(19) United States
(12) Patent Application Publication
(10) Pub. No.: US 2004/0028022 A1
(43) Pub. Date: Feb. 12, 2004

(54) Mobile communication system and terminal with means for displaying multislot transmission

(76) Inventors: Malcolm Teal, Thatcham (GB); Murat Gumussoy, Thatcham (GB)

Correspondence Address: McDermott Will & Emery, 600 13th Street NW, Washington, DC, 20005-3096, US

(21) Appl. No.: 10/415,081

(22) PCT Filed: Oct. 17, 2001
(86) PCT No.: PCT/GB01/04625

(51) Int. Cl. H04J 3/00; H04B 7/212

(52) U.S. Cl. 370/345; 370/347

(57) ABSTRACT

A control apparatus for, and a method of operating, a mobile station in a time division multiplexed access (TDMA) communications system are described. The control apparatus is arranged to determine how many timeslots per TDMA frame are to be or are being employed by the mobile station to transmit data, and to activate an indicator when more than one timeslot per TDMA frame is to be or is being employed. Application to a mobile telephone operating in a GSM/GPRS cellular radio communications system is described.

The present invention relates to a method of operating a mobile telephone in a time division multiplexed access (TDMA) communications system. The present invention is applicable to, but not limited to, mobile telephones for use in cellular radio communications systems such as the General Packet Radio System (GPRS) which is an enhancement of the Global System for Mobile Communications (GSM).

In a cellular communications system, the area over which service is provided is divided into a number of smaller areas called cells. Typically each cell is served from a base transceiver station (BTS) which has an antenna or antennas for radio transmission to and reception from a plurality of user stations, each of which has an antenna for radio transmission to and reception from the BTS. The user stations are normally mobile stations such as mobile telephones, which are sometimes referred to as cellular telephones or cell phones. GSM shares radio resources between different users by employing time division multiplexed access (TDMA). In GSM, each mobile telephone only ever employs one timeslot within a TDMA frame when transmitting.

GPRS (as specified in the “GSM Phase 2+” specification) is an enhanced version of GSM which has been established to enable GSM systems to carry packet switched data. One feature of GPRS is that the number of timeslots within a TDMA frame employed by the mobile telephone when transmitting can vary.

The amount of power consumed by a mobile telephone whilst transmitting radio frequency (RF) radiation can vary according to various circumstances. The power supply of a mobile telephone usually comprises a rechargeable battery. Higher levels of power transmission by the mobile telephone leads to shorter periods of operation before recharging of the battery is required. For this reason, it is desirable to provide the user of a mobile telephone with an indication related to the power level being transmitted to enable a user to curtail a call so as to conserve power.

It is known to determine the power transmission level by means of direct measurements of average power. However, this requires physical sensors to be employed. Moreover, the known method is not adapted for time division multiplexed access arrangements such as GPRS in which the number of timeslots within a TDMA frame employed by the mobile telephone when transmitting can vary.

In a first aspect, the present invention provides a control apparatus for a mobile station, e.g. a mobile telephone, for use in a time division multiplexed access (TDMA) communications system; the control apparatus employing means for discriminating between single-slot transmission and multi-slot transmission, and means for indicating, to a user of the mobile station, the occurrence of multi-slot transmission.

In a second aspect, the present invention provides a control apparatus for a mobile station, e.g. a mobile telephone, of a communications system, wherein the mobile station receives instructions from a control station of the communications system instructing the mobile station which timeslots are to be used for transmission of data bursts; the control apparatus comprising means for analysing the instructions and determining whether the timeslot allocation involves more than one timeslot per TDMA frame being used to transmit a burst of data, and means for activating an indication that more than one timeslot per TDMA frame has been so allocated.

The present invention also provides a mobile station, e.g. a mobile telephone, comprising control apparatus in accordance with the first or second aspect.

Embodiments of the present invention will now be described, by way of example only, with reference to the accompanying drawings, in which:

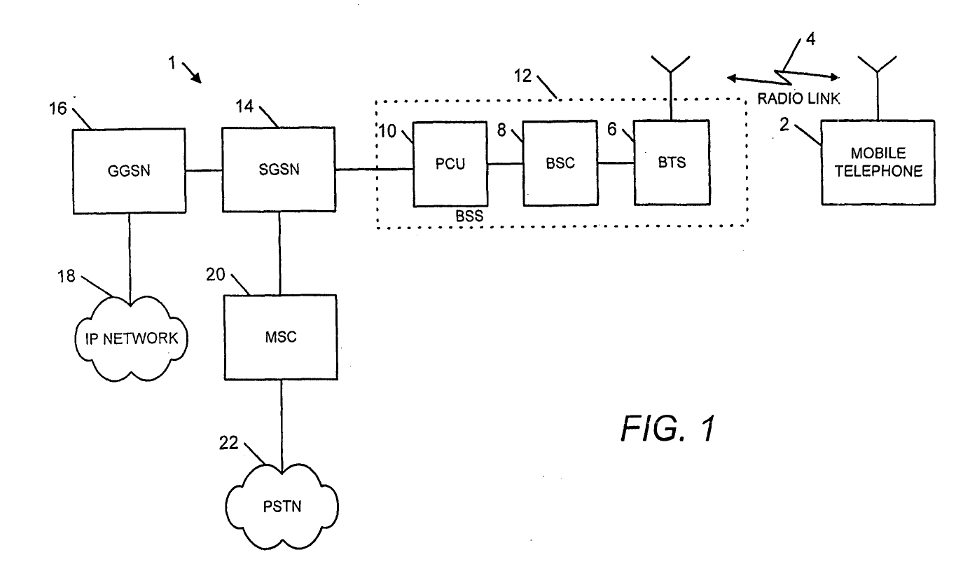

FIG. 1 is a schematic illustration of part of a GSM/GPRS cellular radio communications system;

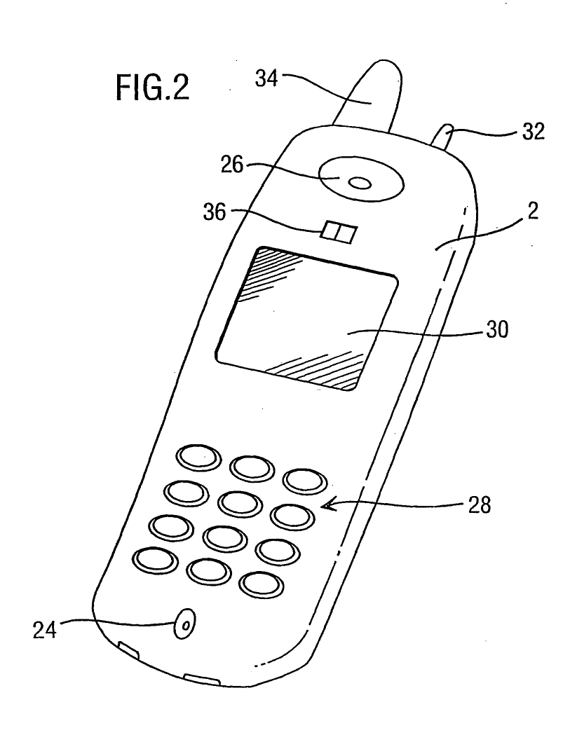

FIG. 2 is an external view of a mobile telephone;

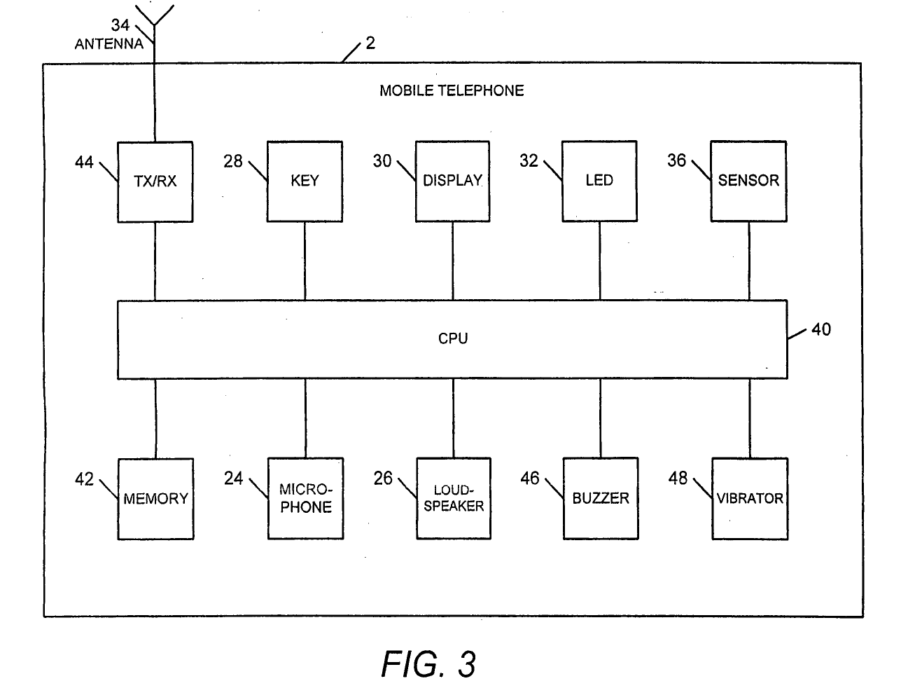

FIG. 3 is a block diagram schematically illustrating functional units of the mobile telephone illustrated in FIG. 2;

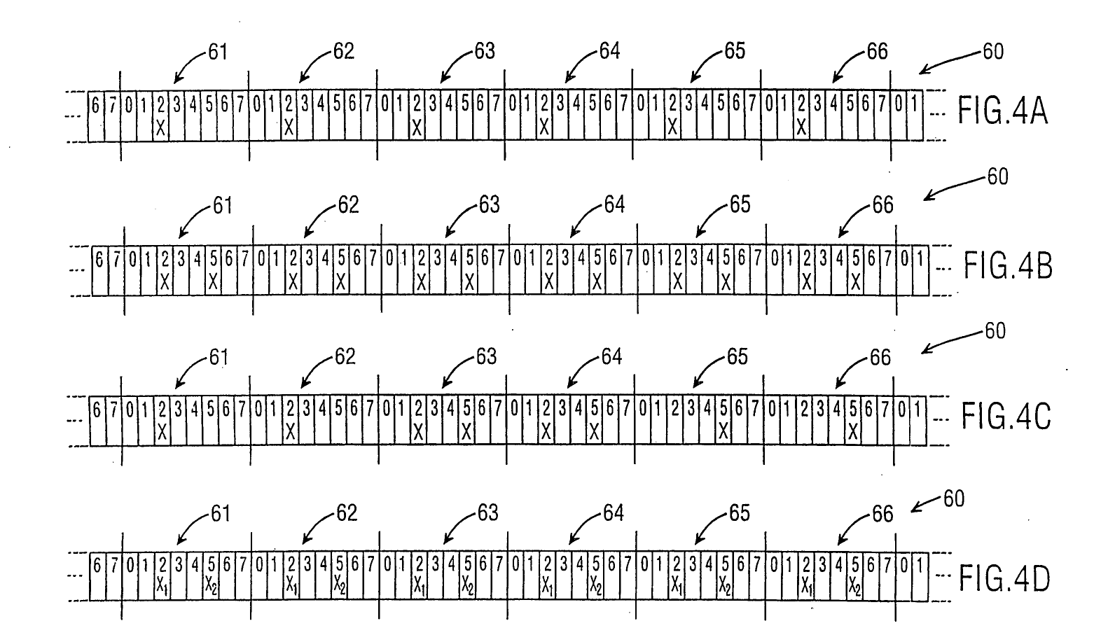

FIG. 4A is a schematic illustration of timeslots arranged in TDMA frames in which bursts of data are assigned on a single-slot basis;

FIGS. 4B, 4C and 4D are schematic illustrations of timeslots arranged in TDMA frames in which bursts of data are assigned on a multi-slot basis;

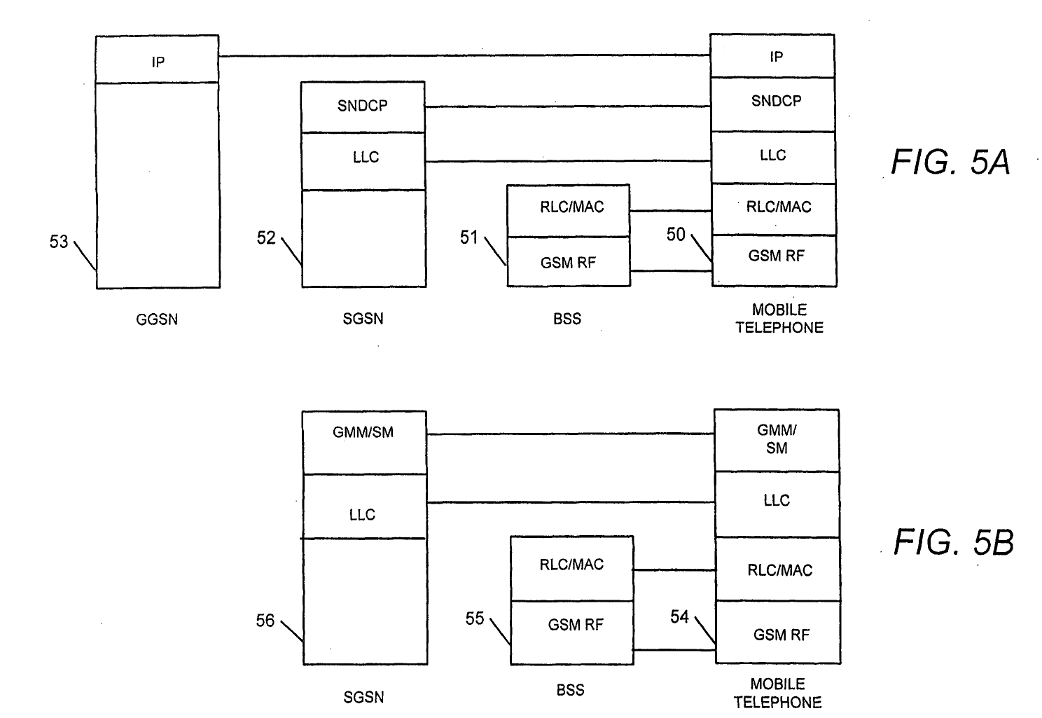

FIG. 5A schematically illustrates transmission protocols for GPRS;

FIG. 5B schematically illustrates signalling protocols for GPRS; and

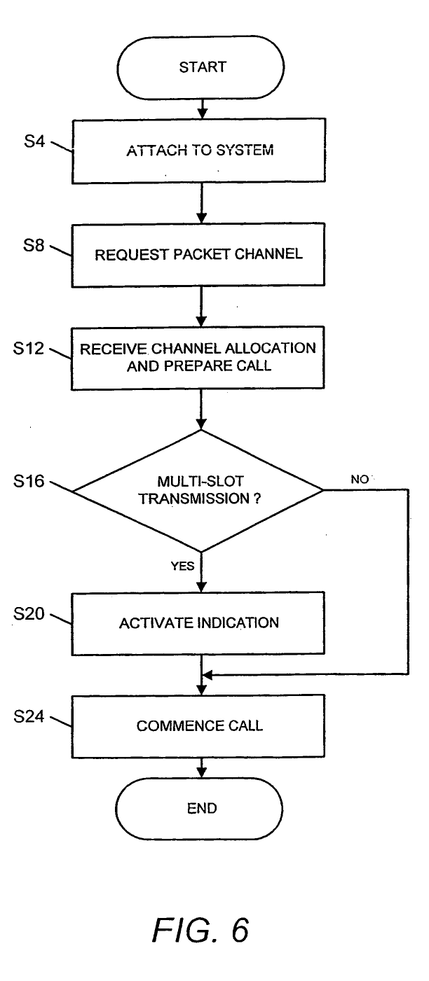

FIGS. 6, 7 and 8 show process steps related to indication of multi-slot transmission as carried out by the mobile telephone illustrated in FIGS. 2 and 3.

FIG. 1 is a schematic illustration of part of a GPRS/GSM cellular radio communications system 1. A large number of mobile telephones are served by the system, however for clarity only one mobile telephone 2 is shown. The mobile telephone 2 employs a radio link 4 established between it and a base transceiver station (BTS) 6. The BTS is coupled to and controlled by a base station controller (BSC) 8. The BSC 8 is coupled to a packet control unit (PCU) 10, which performs packet segmentation, radio channel allocation and quality of service measurements within the constraints of the GPRS specification. In the present embodiment the BTS 6, BSC 8 and the PCU 10 are located together thereby forming a base station system (BSS) 12.

The PCU 10 is coupled to a serving GPRS support node (SGSN) 14. The SGSN 14 performs certain control functions with respect to the PCU 10 for the purpose of managing the mobility of mobile telephones using the system. The SGSN 14 is also coupled to a gateway GPRS support node (GGSN) 16 which serves as the gateway or interface for receipt and transmission of data in packetised form from packet switching networks. FIG. 1 shows an example of a packet switching network, IP network 18, which is a private network operating according to the Internet protocol (IP). The packetised data is forwarded via the GGSN 16 and the SGSN 14 to the PCU 10, and the SGSN 14 counts the data or packets for the purposes of charging. The SGSN 14 also interacts with standard GSM parts of the overall cellular communications system (i.e. those system components processing non-packetised data). For this purpose the SGSN 14 is coupled to a mobile services switching centre (MSC) 20 of a standard GSM system, and the MSC 20 is itself coupled to a public switched telephone network (PSTN) 22.

The geographical area served by the BSS 12 constitutes one cell of the cellular communications system, i.e. the mobile telephone 2 is in this cell. Although not shown, the system contains other cells served by other BSSs.

Further details of the mobile telephone 2 will now be described with reference to FIG. 2, which is an external view of the mobile telephone 2, and FIG. 3 which shows a block diagram schematically illustrating functional units of the mobile telephone 2.

The mobile telephone 2 comprises: a microphone 24 and a loudspeaker 26 enabling the user to input speech and hear audio output respectively; a user interface in the form of a keyboard 28 enabling the user to input numbers to be called, other information and instructions for controlling various features of the mobile telephone 2; a display 30 on which incoming or outgoing telephone numbers and other information can be displayed; a light emitting diode (LED) 32 for providing a visual indication as required, for example indicating when the mobile telephone 2 is receiving service from the cellular communications system; an antenna 34 for transmitting and receiving radio communications over the radio link 4; and a proximity sensor 36 for sensing when an object, such as a user's body, is in close proximity to the mobile telephone 2.

As shown in FIG. 3, the mobile telephone 2 further comprises a central processor unit (CPU) 40 which is coupled to each of the above described items. In the case of the antenna 34, the CPU 40 is coupled thereto via a radio transmitter and receiver (TX/RX) 44, which feeds the signals for transmission to the antenna 34 and retrieves the signals received by the antenna 34. The mobile telephone 2 further comprises a buzzer 46 and a vibrator 48, both of which are coupled to the CPU 40, and which are used either separately or in combination to indicate to the user that a call has been received.

The CPU 40 controls the overall operation of the mobile telephone 2 in compliance with the GSM and GPRS specifications in conventional manner. For this, the CPU 40 employs software which operates at various software layer levels corresponding to protocol hierarchies specified in the GSM and GPRS specifications, as will be explained in further detail below with reference to FIG. 5.

The communications system 1 employs a number of discrete radio frequency (RF) channels. The channels are spaced apart from each other by 200 kHz. Radio transmission on each RF channel is performed according to a TDMA arrangement employing timeslots of 0.577 ms. FIG. 4A schematically illustrates a portion 60 of a sequence of timeslots. The timeslots are arranged in TDMA frames consisting of eight consecutive timeslots, numbered by convention 0 to 7 inclusive. The sequence 60 of timeslots shown in FIG. 4A includes six complete TDMA frames, 61, 62, 63, 64, 65 and 66.

The mobile telephone 2 transmits data to the BTS 6 in discrete bursts in accordance with the TDMA configuration of the cellular communications system 1. Each data burst occupies one allocated timeslot and is fully contained within the duration of the corresponding timeslot.

In operation, the BTS 6 transmits signalling data to the mobile telephone 2 allocating radio link resources which the mobile telephone 2 is to use for transmitting data to the BTS 6. The mobile telephone 2 is allocated a share of one or more of the RF channels, and one or more so-called logical channels as defined in the GSM and GPRS specifications. The logical channels are an arrangement by which data is organised for transmission. One example of a logical channel is the packet data traffic channel (PDTCH) which is allocated to the mobile telephone 2 for transmitting basic information content, i.e. traffic (as opposed to signalling information).

Under GSM/GPRS, the logical channels are allocated to the timeslots in accordance with a scheme in which the TDMA frames are treated as constituting a repeating cycle of 52 consecutive TDMA frames. Under the scheme, for the 52 TDMA frames of each cycle, each timeslot of a given number (e.g. each timeslot numbered 2) is considered to be connected together to form (conceptually) a sequence of 52 timeslots which is called a multi-frame. The BTS 6 allocates logical channels to specific parts of such multi-frames, in accordance with channel assignment protocols defined in the GSM and GPRS specifications. The nett result is that the mobile telephone 2 is assigned specific timeslots of specific TDMA frames, in terms of the repeated cycle of 52 TDMA frames, in which it is to transmit the bursts of data.

The above described logical channels and multi-frames are fully documented in the GSM and GPRS specifications and are well understood by the skilled practitioner. Further details are not required for the purpose of understanding the present embodiment. Rather, irrespective of which logical channels are being allocated, of significance in the present embodiment is the resulting overall allocation of timeslots to the mobile telephone 2 for the purpose of transmitting data to the BTS 6.

The content of the six TDMA frames 61 to 66, in a first example of an allocation under GPRS of bursts to be transmitted from the mobile telephone 2 to the BTS 6, is shown in FIG. 4A. Each burst is indicated by an “X”. In each of the TDMA frames 61 to 66, one, and only one, of the timeslots (in each case the timeslot numbered 2) contains a burst of data. This is termed “single-slot” transmission.

Conventional GSM allows only the single-slot transmission form shown in FIG. 4A. However, GPRS includes more flexible timeslot allocations as a means of accommodating the variable demands that are introduced by packet switching. Specifically, other examples of timeslot allocation in GPRS involve plural timeslots per TDMA frame having respective bursts of data allocated to them. This is termed “multi-slot” transmission. One effect of multi-slot transmission is that more power is consumed by the mobile telephone 2 over a given call duration than would be if single-slot transmission was employed over the same call duration.

In the present embodiment, transmission is considered to be “multi-slot” transmission when at least one of the TDMA frames within the repeated cycle of 52 TDMA frames exhibits multi-slot transmission.

One example of multi-slot transmission is shown in FIG. 4B. In each of the TDMA frames 61 to 66, the timeslots numbered 2 and the timeslots numbered 5 all have bursts of data assigned to them. (This arrangement arises here since a plurality of PDTCH channels are allocated on a single multi-frame, namely the multi-frame corresponding to the timeslots numbered 2).

A further example of multi-slot transmission is shown in FIG. 4C. The TDMA frames 61, 62, 63 and 64 each have bursts of data assigned to their timeslots numbered 2, and the TDMA frames 63, 64, 65 and 66 each have bursts of data assigned to their timeslots numbered 5. (This arrangement arises here since one PDTCH channel is allocated on the multi-frame corresponding to the timeslots numbered 2 and another PDTCH channel is allocated on the multi-frame corresponding to the timeslots numbered 5.) Consequently, the TDMA frames 63 and 64 each have two timeslots with bursts of data assigned to them, and thus this is an example of multi-slot transmission.

Yet a further example of multi-slot transmission is shown in FIG. 4D. In this example, the mobile telephone 2 is assigned two separate frequencies, f₁ and f₂, at which to transmit. The TDMA frames 61 to 66 each have data bursts which the mobile telephone 2 is to transmit at frequency f₁ (indicated by “X₁”) assigned to their timeslots numbered 2, and data bursts which the mobile telephone 2 is to transmit at frequency f₂ (indicated by “X₂”) assigned to their timeslots numbered 5. (This arrangement arises here since a plurality of PDTCH channels are allocated on a single multi-frame, namely the multi-frame corresponding to the timeslots numbered 2, for the RF channel at frequency f₁, and a further plurality of PDTCH channels are allocated on a single multi-frame, namely the multi-frame corresponding to the timeslots numbered 5, for the RF channel at frequency f₂.)

It is to be understood that the different timeslot assignment examples described above with reference to FIGS. 4A, 4B, 4C and 4D are not exclusive alternatives. Rather, any of the examples may be allocated to the mobile telephone 2 for any particular call or other type of data transfer session. Moreover, the different examples may occur in combination during a single call. This can arise since a process known as dynamic allocation, in which the allocation of timeslots is varied with time, is specified in GPRS.

Thus, to summarise, in the present embodiment the mobile telephone 2 follows assignment instructions according to any one or any combination of the examples shown in FIGS. 4A, 4B, 4C and 4D. When transmitting according to the example shown in FIG. 4A, the mobile telephone 2 performs single-slot transmission and when transmitting according to the examples of FIGS. 4B, 4C or 4D, the mobile telephone 2 performs multi-slot transmission.

In the present embodiment, the CPU 40 determines whether the mobile telephone 2 is performing single-slot or multi-slot transmission by employing software which is structured in software layers in correspondence to certain protocol layers defined in the GSM and GPRS specifications. These protocol layers will now be described.

The protocols are data-format and communication protocols. The different entities (e.g. the mobile telephone 2, the BSS 12, the SGSN 14, the GGSN 16 etc.) of the cellular radio communications system 1 follow the protocols so that signalling and traffic data conveyed through the system 1 can be uniformly understood and processed at the different entities. The protocols are organised hierarchically with the protocols applied to a particular entity each forming a layer of a protocol stack for that entity. The protocols are well understood by the skilled practitioner, and hence only certain protocols helpful for understanding the present embodiment will now be described further with reference to FIGS. 5A and 5B.

FIG. 5A schematically illustrates some of the transmission protocols of GPRS which serve to transfer a data packet between the mobile telephone 2 and the GGSN 16. The arrangement includes respective transmission protocol stacks 50, 51, 52 and 53 for the mobile telephone 2, the BSS 12, the SGSN 14 and the GGSN 16.

The lowest protocol layer is a “GSM RF” protocol layer which is present in the mobile telephone stack 50 and the BSS stack 51. The GSM RF protocol layer is for the radio communications between the mobile telephone 2 and the BTS 6 over the radio link 4. The GSM RF protocol layer contains basic protocols for implementing the TDMA and radio frequency modulation details described above with reference to FIG. 4. This protocol layer corresponds to an equivalent layer in the standard GSM specification for non-packetised data.

A further protocol layer present in the mobile telephone stack 50 and the BSS stack 51 contains the radio link control (RLC) which provides improved reliability over the radio link 4 and a medium access control (MAC) which controls access signalling across the radio link 4.

A protocol layer present in the mobile telephone stack 50 and the SGSN stack 52 is the logical link control (LLC) which provides an encrypted logical link between the SGSN 14 and the mobile telephone 2. The LLC protocol is independent of the GSM RF protocol.

A further protocol layer present in the mobile telephone stack 50 and the BSS stack 51 is a sub-network dependent convergence protocol (SNDCP). This is responsible for converting packet formats as appropriate, and includes for example responsibility for data compression and segmentation.

A protocol layer present in the mobile telephone stack 50 and the GGSM stack 53 is the Internet protocol (IP) which is used to route user data and signalling information.

FIG. 5B schematically illustrates some of the signalling protocols of GPRS for controlling and supporting the above described functions of transferring a data packet across the interfaces between the different entities. The arrangement includes respective signalling protocol stacks 54, 55 and 56 for the mobile telephone 2, the BSS 12 and the SGSN 14.

Certain protocol layers are the same as in the transmission protocol stacks, namely the GSM RF protocol layer and the RLC/MAC protocol layer contained in the mobile telephone stack 54 and the BSS stack 55, and the LLC protocol layer contained in the mobile telephone stack 54 and the SGSN stack 56. In addition, the mobile telephone stack 54 and the SGSN stack 56 have a further protocol layer for GPRS mobility management (GMM) and session management (SM). This protocol layer contains protocols supporting such functions as attach and detach of mobile telephones to the GPRS part of the cellular communications system 1 and security.

The CPU 40 of the mobile telephone 2 operates software which implements the above-described protocols. The software is structured as software layers corresponding to the described protocol layers. The software layer implementing the GSM RF protocol layer is termed layer one software. Operation of the layer one software includes determining in which timeslots bursts of data need to be transmitted and implementing the timing of the transmission of the bursts of data accordingly. In the present embodiment, the layer one software is used by the CPU 40 to determine whether the mobile telephone 2 is engaged in single-slot or multi-slot transmission.

The process steps carried out by the mobile telephone 2 when implementing the present embodiment will now be described with reference to FIG. 6.

In response to being switched on by a user, at step S4 the mobile telephone 2 undertakes a handshake process with the BTS 6 by communicating over the radio link 4. The mobile telephone 2 thereby becomes attached to the cellular communication system 1, that is it is in communication with the system and can receive service therefrom. The handshake procedure is implemented in conventional fashion according to the requirements laid down in the GPRS specification.

One detail of particular significance with respect to the present embodiment is that the mobile telephone 2 initiates the handshake procedure by issuing an “attach request” which includes details of the “classmark” of the mobile telephone 2. The classmark is a set of data specifying characteristics and capabilities of the mobile telephone 2, including its multi-slot capabilities. There are 29 multi-slot classes of mobile telephone defined in GPRS, each corresponding to a different selection of maximum number of timeslots that a mobile telephone can cope with in multi-slot mode. Each class is defined in terms of a maximum number of received timeslots per frame, a maximum number of transmit timeslots per frame, and a maximum total number of receive and transmit timeslots per frame. The step S4 of the mobile telephone 2 attaching to the cellular communication system 1 is performed under the control of the CPU 40, using a software layer implementing the GMM/SM protocols described earlier above with reference to FIG. 5B.

The mobile telephone 2 is able to request either standard GSM service, in which case it requests a standard GSM traffic channel, or packet-switching service under GPRS, in which case it requests a packet channel (the terminology “a packet channel” encompasses all the channel resources required to be allocated for the mobile telephone 2 to engage in packet switched data transfer). At step S8, the mobile telephone 2 requests a packet channel from the cellular communications system 1, by sending a packet channel request on a logical channel called the packet random access channel (PRACH). In the present example, the packet channel is being requested in response to the user of the mobile telephone 2 initiating a call in which the user will conduct conventional speech but during which text and other data will also be transmitted. A further handshake procedure takes place between the mobile telephone 2 and the cellular communications system 1 (via BTS 6), resulting in the cellular communications system (via BTS 6) issuing a channel allocation.

At step S12 the mobile telephone 2 receives the channel allocation and prepares to proceed with the call for which it has requested the packet channel. The channel allocation received from the cellular communication system 1 includes details of which timeslots are to be employed by the mobile telephone 2 when transmitting the data of a call.

At step S16, the CPU 40 determines whether the received channel allocation will require the mobile telephone 2 to perform multi-slot transmission using its layer one software as was described in detail earlier with reference to FIGS. 4A to 4D and FIGS. 5A and 5B.

In the present example the received channel allocation produces the timeslot arrangement shown in FIG. 4B, thus the CPU 40 indeed determines that multi-slot transmission is to occur. The process therefore moves to step S20 in which the mobile telephone 2 indicates to the user that multi-slot transmission is to occur. In the present embodiment, the indication is implemented by sounding the buzzer 46 of the mobile telephone 2 for a period of two seconds. The buzzer is activated at a lower volume than when indicating to the user of the mobile telephone 2 that the mobile telephone 2 is being paged.

After the indication to the user that multi-slot transmission is to occur has been activated at step S20, the mobile telephone 2 commences the call (step S24). As the user has received indication of multi-slot transmission before the call commences, he is able to conduct the call in the light of this knowledge. At this stage, the process steps related to the multi-slot transmission indication are completed, and the mobile telephone 2 operates in conventional fashion for the rest of the call.

If the received channel allocation had instead produced the timeslot arrangement shown in FIG. 4A, then at step S16 the CPU 40 would have determined that multi-slot transmission was not to occur, and hence the process would have moved on directly to step S24 where the mobile telephone 2 would have commenced the call.

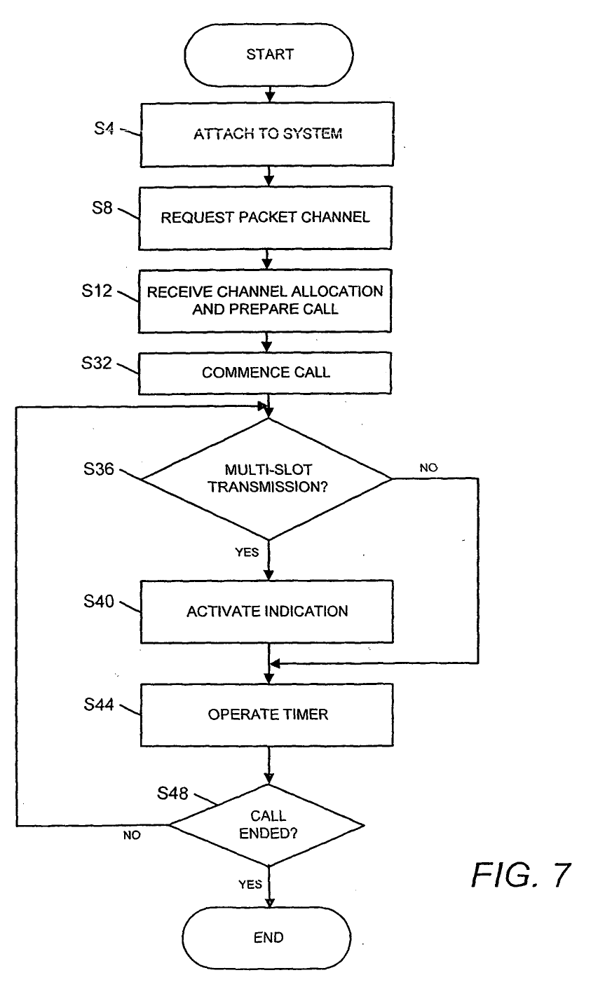

In the above embodiments, the indication of multi-slot transmission was made to the user of the mobile telephone 2 before the call commenced. Under GPRS, it is possible for the allocation of timeslots and channels to vary with time during a call, under the above described process known as dynamic allocation. Dynamic allocation is particularly well accommodated in an alternative embodiment of the present invention, which will now be described with reference to FIG. 7 which shows the process steps carried out by the mobile telephone 2.

The mobile telephone 2 performs the step S4 of attaching to the cellular communications system, the step S8 of requesting a packet channel, and the step S12 of receiving channel allocation and preparing a call, in the same way as in the above described first embodiment.

At step S32, the mobile telephone 2 commences the call. Thereafter, at step S36, the CPU 40 determines whether multi-slot transmission is occurring at the start of the call. If multi-slot transmission is occurring, then at step S40 the mobile telephone 2 activates an indication of the multi-slot transmission to the user of the mobile telephone 2. As in the case of the first embodiment, the indication comprises sounding the buzzer 46, at a lower volume than is used for indicating paging. Again, the buzzer is sounded for two seconds.

Thereafter, at step S44, the CPU operates a timing function so as to determine when a fixed amount of time, in this example 20 seconds, has passed. After 20 seconds has passed, the CPU 40 checks, at step S48, whether the call has ended. If the call has not ended, then the process returns to step S36 where the CPU 43 determines whether multi-slot transmission is now occurring. This process is repeated at 20 second intervals, so that if, due to dynamic allocation, multi-slot transmission commences at some stage during the call, the user is made aware of this.

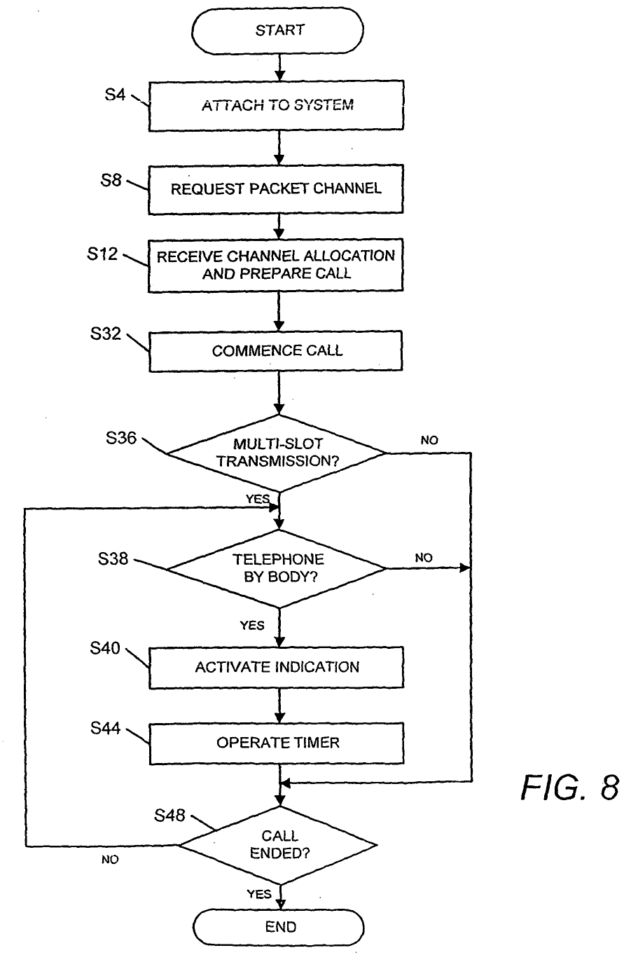

A further embodiment will now be described with reference to FIG. 8, which again shows the process steps carried out by the mobile telephone 2. In this further embodiment the mobile telephone 2 carries out all the steps of the previous embodiment in the same manner, except as follows.

If, at step S36, the mobile telephone 2 determines that multi-slot transmission is indeed occurring, then the mobile telephone 2 carries out a further determination step S38. The mobile telephone 2 employs the proximity sensor 36 to determine whether the mobile telephone 2 is positioned by the body of a user. In this embodiment the proximity sensor 36 comprises an infra-red emitting diode and a photosensor, arranged so that the amount of the emitted radiation from the infra-red emitting diode returning to the photosensor depends on whether an object is in proximity thereto and thus reflecting the radiation. The CPU 40 has a pre-programmed threshold for the signal level that corresponds to the mobile telephone 2 being held directly against the head of the user. The process only moves on to step 40 in which the CPU 40 activates indication of multi-slot transmission when the output of the proximity sensor 36 is higher than the threshold. If instead it is determined that the mobile telephone 2 is not by the user's body, then indication of multi-slot transmission is not activated, and instead the process moves on to step S44. This can arise, for example, when the mobile telephone 2 is used to transmit data but no speech.

Furthermore, instead of the proximity sensor 36 being used at step S38 to determine whether the mobile telephone 2 is positioned by the user's head, the mobile telephone 2 can instead determine this by detecting whether or not a “hands-free” kit (comprising an external microphone and loudspeaker which are connected to the mobile telephone to enable the user to speak and listen via the mobile telephone 2 without placing the mobile telephone 2 by his head) is being used. In this case, at step S38 the CPU 40 determines whether the telephone is by the user's body by determining whether the hands-free kit is being used or not.

In the above embodiments, multi-slot transmission was considered to be occurring provided any TDMA frame within the repeating cycle of 52 TDMA frames contained two or more timeslots with bursts of data allocated to them. In other embodiments, other criteria may be used. For example, the proportion of TDMA frames comprising data bursts in more than one timeslot may be determined, and compared to a threshold. Alternatively; there may be a requirement for a minimum number of consecutive TDMA frames to have bursts of data allocated to more than one timeslot. Alternatively, one particular TDMA frame may be selected at random, and if it has multiple slots with data bursts in then that can provide the overall determination of multi-slot transmission. A further alternative is to specify that multi-slot transmission is occurring in the event that any minimum number of TDMA frames over a given time include multiple bursts of data. In this case, the minimum number required may even be set at one. This would be one simple way of discriminating between GPRS operation and standard GSM operation.

In the above embodiments, the CPU 40 implemented determination of whether multi-slot transmission was occurring by use of its layer one software, which functions in relation to the GSM RF protocols forming part of the protocol stack for the mobile telephone 2. In other embodiments, the CPU 40 may employ higher level software related to the various higher layers of protocol shown in FIGS. 5A and 5B. In this case, it is possible for the CPU 40 to ascertain whether detected multi-slot transmission is specified to be sustained, or may vary due to being dynamically allocated. Consequently, in such embodiments the mobile telephone 2 may additionally analyse whether any multi-slot transmission is to be sustained or not before activating indication of the multi-slot transmission.

In the above embodiments, the indication of multi-slot transmission was implemented by sounding the buzzer 46 continuously for a period of two seconds. Such indication may alternatively be implemented for other periods of time, or all through a call, or up until the next time determination of whether multi-slot transmission is occurring takes place, or on some other periodic basis throughout the call.

Furthermore, the indication may be implemented by sounds provided through the microphone 24, or some other audio source. A further alternative is that a visual indication is provided either instead of or in addition to such audio indication. One possibility is for the LED 32 to be activated in some suitable fashion, for example by flashing on and off or by providing a different colour of illumination compared to its usual colour of illumination. Similarly, a message may be displayed on the display 30. Yet further, the vibrator 48 may be employed. Also, any combination of the above described indication means may be employed.

A further possibility is that the mobile telephone 2 is arranged to usually indicate single-slot transmission, and multi-slot transmission is then indicated by removal of the usual indication of single-slot transmission.

In the above embodiments, indication to the user of multi-slot transmission was implemented in the same fashion irrespective of how many timeslots per TDMA frame contained bursts of data. In alternative embodiments, the indication is implemented so as to indicate to the user a measure, either, exact or approximate, of how many timeslots per TDMA frame contain bursts of data. In these embodiments, any suitable approximation can be employed for specifying the number of timeslots, in the event that the TDMA frames do not all employ the same number of timeslots. For example, the most common occurrence can be selected as the value to be indicated, or alternatively the average value over a cycle of 52 repeated frames can be indicated. Any suitable way of indicating the number of timeslots involved in the multi-slot transmission per TDMA frame can be employed, and the level of suitability will depend upon how the indication is being implemented. For example, in the case of the buzzer 46 being sounded, this can be sounded for a number of pulses equal to the number of timeslots per TDMA frames containing data bursts. In the case of a message, displayed by display 30 or announced through the loudspeaker 26, the information can be included explicitly.

In the above embodiments, the RF channel or channels on which the mobile telephone 2 is required to transmit to the BTS 6 is fixed. In other embodiments, frequency hopping is employed for the transmissions, in which the particular RF channel or channels which the mobile station is allocated varies.

The above embodiments relate to a mobile telephone operating in a GPRS-enhanced GSM cellular communications system. It is to be appreciated that the present invention is not limited to such an arrangement, and instead can be applied to any communications system operating on a TDMA basis in which multi-slot allocations can occur. The present invention can also be applied to any mobile communications apparatus for which it would be advantageous to indicate to the user whether multi-slot or single-slot transmission is occurring. Thus it is to be appreciated that the present invention can be applied to TDMA cellular communications systems other than GSM. This includes combined TDMA/code division multiplexed access (CDMA) systems.

It is further to be appreciated that, although in the specific example of GPRS, multi-slot transmission is employed so as to cope with the flexible demands of packet switching, nevertheless the present invention applies to other TDMA systems which employ single-slot and multi-slot transmission even though packet switching is not undertaken.

In each of the above embodiments, the CPU 40 is configured with program instructions and/or data. Such program instructions and/or data may be pre-stored in a storage medium such as a PROM, for example forming part of the memory 42.

The above embodiments have all been described in relation to the specific mobile telephone 2 as illustrated in FIGS. 2 and 3. It is to be appreciated that other forms of mobile telephone or similar apparatus can be employed, and that none of the specific components shown as part of the mobile telephone 2 are essential to the present invention. Similarly, part or all of the procedures of the present invention can be carried out by components other than a CPU, e.g. dedicated circuitry.

1. A method of operating a mobile station in a time division multiplexed access, TDMA, communications system in which timeslots are arranged in TDMA frames; the method comprising the following steps:
determining how many timeslots per TDMA frame are to be or are being employed by the mobile station to transmit data to a receiver station of the communications system; and
indicating when more than one timeslot per TDMA frame is to be or is being employed.

2. A method according to claim 1, wherein the determining step is performed before the mobile station starts a call to transmit the data.

3. A method according to claim 1, wherein the determining step is repeated periodically during a call to transmit the data.

4. A method according to any preceding claim, wherein the indicating step comprises activating a visual indicating means, preferably an LED or display of the mobile station.

5. A method according to any preceding claim, wherein the indicating step comprises activating an audio indicating means, preferably a buzzer or loudspeaker of the mobile station.

6. A method according to any preceding claim, wherein the indicating step comprises activating a vibrator of the mobile station.

7. A method according to any preceding claim, wherein the indicating steps comprises indicating how many timeslots per TDMA frame are to be or are being employed.

8. A method according to any preceding claim, further comprising determining whether the mobile station is located by the body of a user and carrying out the indicating step in response to it being determined that the mobile station is located by the body of the user.

9. A method according to claim 8, wherein the step of determining whether the mobile station is located by the body of a user is performed using a proximity sensor of the mobile station.

10. A method according to claim 8, wherein the step of determining whether the mobile station is located by the body of a user is performed by determining whether a hands-free kit is being used.

11. A method according to any preceding claim, wherein the TDMA communications system is a cellular radio communications system, preferably a GPRS system.

12. A control apparatus for a mobile station for use in a time division multiplexed access, TDMA, communications system in which timeslots are arranged in TDMA frames; the apparatus comprising:
determining means for determining how many timeslots per TDMA frame are to be or are being employed by the mobile station to transmit data to a receiver station of the communications system; and
control means for activating indicating means to indicate to a user when more than one timeslot per TDMA frame is to be or is being employed.

13. An apparatus according to claim 12, wherein the determining means is arranged to determine how many timeslots per TDMA frame are to be or are being employed before the mobile station starts a call during which the data is transmitted.

14. An apparatus according to claim 12, wherein the determining means is arranged to determine how many timeslots per TDMA frame are to be or are being employed periodically during a call during which the data is transmitted.

15. An apparatus according to any of claims 12 to 14, comprising a visual indicating means, preferably an LED or a display.

16. An apparatus according to any of claims 12 to 15, comprising an audio indicating means, preferably a buzzer or a loudspeaker.

17. An apparatus according to any of claims 12 to 16, comprising indicating means comprising a vibrator.

18. An apparatus according to any of claims 12 to 17, wherein the control means is arranged to activate the indicating means so as to indicate how many timeslots per TDMA frame are to be or are being employed.

19. An apparatus according to any of claims 12 to 18, further comprising location determining means for determining whether the mobile station is located by the body of a user, and wherein the control means is arranged to activate the indicating means when more than one timeslot per TDMA frame is to be or is being employed provided that the location determining means has determined that the mobile station is located by the body of the user.

20. An apparatus according to claim 19, wherein the location determining means comprises a proximity sensor.

21. An apparatus according to claim 20, wherein the location determining means comprises means for detecting whether a hands-free kit is being used.

22. An apparatus according to any of claims 12 to 21, adapted for use in a cellular radio communications system, preferably a GPRS system.

23. A controller for a communications transmitter operable to transmit data bursts in time division multiplexed access timeslots arranged in frames; comprising means for providing to a user an indication that the transmitter is or is about to perform multi-slot transmission.

24. A mobile telephone for use in a cellular radio communications system, comprising control apparatus according to any of claims 12 to 22 or a controller according to claim 23.

25. A communications system comprising a mobile telephone according to claim 24.

26. A storage medium storing processor-implementable instructions for controlling one or more processors to carry out a method according to any of claims 1 to 11.
